(19) United States
(12) Patent Application Publication
(10) Pub. No.: US 2012/0315475 A1
(43) Pub. Date: Dec. 13, 2012

(54) HEAT-RESISTANT ANTI-STATIC ADHESIVE FILM

(75) Inventors: DEIN-RUN FUNG, TAIPEI (TW); CHI-MING CHANG, TAIPEI (TW); CHUN-CHE TSAO, TAIPEI (TW); SHIH-HSUN YEN, TAIPEI (TW)

(73) Assignee: NAN YA PLASTICS CORPORATION, TAIPEI (TW)

(21) Appl. No.: 13/242,266

(22) Filed: Sep. 23, 2011

(30) Foreign Application Priority Data
Jun. 13, 2011 (TW) 100120539

(51) Int. Cl. B32B 7/12

(52) U.S. Cl. 428/352

(57) ABSTRACT

The invention provides a heat-resistant anti-static adhesive film having at least includes a top film, a silane-treated release layer on an underlying substrate layer, and a pressure-sensitive adhesive layer coated over the release layer. The pressure-sensitive adhesive layer is obtained by adding a plasticizer, an ionic compound or an anti-static agent, a cross-linking agent and aliphatic or alicyclic multi-functional isocyanate into (meth)acrylate polymer of the reactive silane compound. The composition has a long working life (pot life) of up to 24 hours and anti-static capability. A pressure-sensitive patch or surface protective film containing the abovementioned composition in the form of sheets or strips is capable of standing high temperature of 150 for up to 3 hours without leaving glue residue.

### BACKGROUND OF THE INVENTION

1. Field of the Invention

The present invention relates to an adhesive composition having long working life (pot life) of up to 24 hours, and pertains particularly to an adhesive composition having long working life, high heat-resisting, and anti-static characteristics suitable for being applied in adhesive protective films.

2. Description of Related Art

Surface protective films are widely and frequently applied on plastic and metal surfaces for protective purposes. The adhesive ability of the surface protective film onto a surface of protection comes from the adhesive material coated on the inner surface thereof, the purpose is to protect an object from being damaged or contaminated while being processed or transported. The adhesive for the surface protective film generally uses acrylic adhesive for concerns of optical properties such as weather resistance and transparency. The acrylic adhesive is mainly made by polymerizing (meth)acrylate with monomers having various functional groups such as hydroxyl. When in use, it is further subject to cross-linking reaction to appropriate degree with other compounds such as isocyanate compounds or epoxy compounds. However, when a crosslinking agent is added to the manufacturing processing formula, the viscosity increases as time elapses, causing significantly decrease in available coating time (pot life), so that there is time limit on production operation, increase in cleaning procedures and possible contamination.

Previously, the operating time (pot-life) of the above adhesive can be extended as follows. In the adhesive is added keto-enol tautomer compounds (refer to patent document 1, Laid-Open 2005-247909). However, such a method can extend the pot life up to 8 hours, and may cause metal corrosion which results in damage to the product equipment. For a continuous production process, it may increase the cleaning processes and the possibility of contamination.

In order to meet the needs of heat resisting requirements during the manufacturing process of LCD panels such as touch panels, the heat resistance of the protective film has gradually drawn attention. All the existed patents fail to disclose how to improve the heat resistance of protective films. Therefore, there is a need for a novel adhesive composition which overcomes the above disadvantages.

### SUMMARY OF THE INVENTION

The object of the present invention is to provide an adhesive composition having a pot life of up to 24 hours, and has characters of static resistance, heat resistance and aging resistance. Some of advantages of the composition of the invention are for example that pollution and equipment damages caused by continuous production can be improved, streamlining the operational procedures. A pressure-sensitive patch or surface protective film containing the instantly disclosed composition in the form of sheets or strips is capable of standing high temperature of 150° C. for up to 3 hours without leaving glue residue

The composition of the invention at least includes a top film, a silane-treated release layer on an underlying substrate layer, and a pressure-sensitive adhesive layer coated over the release layer. The pressure-sensitive adhesive layer is obtained by uniformly coating an adhesive composition on the release layer and drying the solvent from the adhesive composition.

The above pressure-sensitive adhesive mainly contains:

A. a (methyl)acrylic polymer-containing reactive silane compound in the amount of 100 PHR;

B. a plasticizer in the amount of 0.1 to 30 PHR;

C. an ionic compounds or antistatic agent in the amount of 0.01o PHR;

D. a cross-linking agent in the amount of 0.01 to 15 PHR.

The (methyl)acrylic polymer of the reactive silane compound is a polymer made the following main components:

a. 0.01 to 5% by weight of reactive silane compounds;

b. 0.5 to 30% by weight of (meth)acrylate containing epoxy-ethyl(propyl);

c. 10 to 90% by weight of alkyl(meth)acrylate;

d. 1 to 30% by weight of (meth)acrylate containing hydroxyl; and

e. 0.01 to 0.15% by weight of carboxylic acid monomers.

After the above components (a)-(e) are subject to polymerization, at least one of the plasticizer, the ionic compound, the antistatic agent, the cross-linking agent, and aliphatic or alicyclic multi-functional isocyanate cross-linking agent is added.

The reaction of the carboxylic acid-containing monomer and the crosslinking agent can promote the bridging effect. However, the longer the storage time, the higher the degree of cross-linking reaction is, which makers the viscosity higher and the coating non-uniform. Therefore, in the present invention, the amount of the (meth)acrylic acid polymer is controlled to the optimum cross-linking degree. Furthermore, by adding plasticizers into the formula, binding energy between molecular chains of the adhesive is reduced so as to extend the coating time (pot life) up to 24 hours so that mobility for the coating process can be maintained.

In addition, epoxy polymer ethyl(propyl)alkyl and the ionic compound or the antistatic agent is charged into and reacts with the adhesive composition of the present invention. With the resulted polar coordinate covalent, the ionic compound or the anti-static agent is not easy to leak out, reducing pollution generated from the processing operations while granting good anti-static property. In order to solve the sticking and easy blistering problem for the polymer which causes by the existence containing epoxy ethyl(propyl)alkyl, introduction of silane compound into the polymer in the invention can reduce the surface tension and increases the ability to remove bubbles, ensuring the uniformity of the coating. Furthermore, the reactive silane compound has significantly good heat resistance, helping improve the heat aging resistance while preventing any adhesive residue. By using a dynamic mechanical analyzer (DMA) to analyze an elastic modulus E′ value of the reactive silane compound. It is found that the elastic modulus E′ of the reactive silane compound increases at high temperatures.

In order to further the understanding regarding the present invention, the following embodiments are provided along with illustrations to facilitate the disclosure of the present invention.

### BRIEF DESCRIPTION OF THE DRAWINGS

The FIGURE is a schematic view of a layered structure of an anti-static adhesive film according to one embodiment of the invention.

### DETAILED DESCRIPTION OF THE PREFERRED EMBODIMENTS

The aforementioned illustrations and following detailed descriptions are exemplary for the purpose of further explaining the scope of the present invention. Other objectives and advantages related to the present invention will be illustrated in the subsequent descriptions and appended tables.

In the FIGURE the antistatic adhesive film 10 of the present invention includes a substrate layer 20, a release layer 30, a pressure-sensitive adhesive layer 40 and a top film 50 laminated in sequence. The substrate layer 20 is used as a bottom layer. The release layer 30 is coated on the substrate layer 20. The pressure-sensitive adhesive layer 40 is coated on the release layer 30 in a manner to be easy to tear off during use. The top film 50 is adhered to the surface of the pressure-sensitive adhesive 40.

The substrate layer 20 can be chosen from a variety of plastic films and sheets, including polyester substrate made of polyethylene (PE), polypropylene (PP), ethylene/propylene copolymer, ethylene/vinyl acetate copolymer (EVA), polyethylene terephthalate (PET), polyethylene terephthalate (PBT) or polyvinyl chloride (PVC). Moreover, the substrate layer 20 of polyester substrate can be stretched or subject to the similar processing so as to adjust the physical properties of the polyester substrate.

In the antistatic adhesive film 10 of the invention, the release layer 30 is a polysiliconoxide-treated release layer between the substrate layer 20 and the pressure-sensitive adhesive layer 40.

In the antistatic adhesive film 10 of the invention, the pressure-sensitive adhesive layer 40 consists of:

A. a (meth)acrylic polymer containing reactive silane compounds, in the amount of 100 PHR;

B. a plasticizer, in the amount of 0.1 to 30 PHR;

C. an ionic compound or anti-static agent, in the amount of 0.01 to 30 PHR;

D. a cross-linker, in the amount of 0.01 to 15 PHR.

It is characterized in that the (meth)acrylic polymer containing reactive silane compounds is a polymer made the following main components:

a. 0.01 to 5 weight % of reactive silane compounds;

b. 0.5 to 30% by weight of alkyl(meth)acrylate containing epoxy-ethyl(propyl);

c. 10 to 90% by weight of alkyl(meth)acrylate;

d. 1 to 30% by weight of the hydroxyl of the (meth)acrylate;

e. 0.01 to 0.15% by weight of the carboxylic acid of the monomer.

### Reactive Silane Compounds

In the present invention the amount of the reactive silane compounds is preferably 0.01 to 5 wt %, more preferably 0.05 to 1 weight %.

Reactive silane compounds are based on acrylic-based silane compounds A, or a sol gel prepared with reactive functional groups of silane compounds B. Structures of the A, B are as follows.

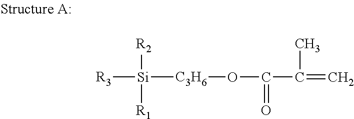

R₁, R₂, R₃ are OCH₃ or OC₂H₅

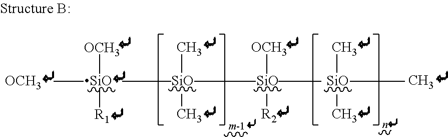

R₁ is an acrylic-containing group; R₂ is a reactive functional group containing OH group, epoxy group, amine group; and m, n are respectively an integer greater than or equal to 1.

### Alkyl(Meth)Acrylate Containing Epoxy Ethyl(Propyl)

In the alkyl(meth)acrylate containing epoxy-ethyl(propyl), the number containing epoxy-ethyl(propyl) units is preferably 2 to 30, and more preferably 10-20.

The amount of (meth)acrylate containing epoxy-ethyl alkyl is preferably 0.5 to 30 weight %, and more preferably 10 to 30 weight %.

The (meth)acrylate containing epoxy-ethyl is selected from 2 (2-ethoxy)ethyl(meth)acrylate, methoxy polyethylene glycol(meth)acrylate, polyethylene glycol(meth)acrylate, polypropylene glycol(meth)acrylate, polyethylene glycol alkyl(meth)acrylate and so on.

### Alkyl(Meth)Acrylate

Any ingredients other than the above monomer composition can also be used, for example acrylates with alkyl having carbon number of 6-14, such as (meth)acrylic acid hexyl ester, (meth)acrylic acid 2-ethylhexyl ester, (meth)acrylic acid octyl ester, (meth)acrylic acid iso-octyl ester, (meth)acrylic acid n-nonyl ester, (meth)acrylic acid isononyl ester, (meth)acrylic acid n-decyl ester, (methyl)acrylic acid isodecyl ester, (meth)acrylic acid n-dodecyl ester, (meth)acrylic acid thirteen carbon-based ester, and (meth)acrylic acid fourteen carbon-based ester. By using these acrylic polymers containing acrylic acid alkyl esters of 6-14 carbons, it can be easily to control the adhesion against the protected object to a low degree while obtain excellent availability can be further stripping.

### Hydroxyl-Containing (Meth)Acrylate

The functional groups used to improve adhesion or for cross-linking points includes (meth)acrylic acid 2-hydroxy ethyl ester, (meth)acrylic acid 2-hydroxy propyl ester, (meth)acrylic acid 4-hydroxy butyl ester, (meth)acrylate 6-hydroxyhexyl ester, (meth)acrylate 8-hydroxy octyl ester, (meth)acrylate 10-hydroxy decyl ester, (meth)acrylate 12-hydroxy lauryl ester, acrylic acid (4-hydroxy-methyl-cyclohexyl)methyl ester, N-hydroxymethyl (meth) acrylamide, vinyl alcohol, allyl alcohol, 2-hydroxy ethyl vinyl ether, 4-hydroxy butyl vinyl ether and diethylene glycol monovinyl ether.

### Carboxylic Acid Monomer

For the proper control of the cohesive strength or improve heat resistance of the composition, carboxylic acid-containing monomers or monomers containing anhydride, such as acrylic acid and methacrylic acid, can be used alone or mixed with more than one of them.

The carboxylic acid monomer content of the acrylic polymer is adjusted to 0.15 weight % or preferably less than 0.15 weight %. When the carboxylic acid monomer content of the acrylic polymer is higher than 0.15 weight %, the adhesive viscosity increases exponentially with storage time, which may reduce the available pot life for use.

After the “(meth)acrylic polymer containing reactive silane compounds” disclosed in the invention is subject to polymerization, by (a) (e) polymerization, the plasticizer, the ionic compound or the antistatic agent, the aliphatic or alicyclic multi-functional isocyanate cross-linking agent is added to form the pressure-sensitive adhesive layer 40.

### Plasticizer

The plasticizer used in this invention can be aliphatic ester-based plasticizers, phosphate-based plasticizers or polyester-based plasticizers. The amount of the plasticizer is 0.1 to 30 parts by weight, preferably 0.5 to 20 parts by weight, and more preferably 1 to 10 parts by weight relative to 100 parts by weight of the polymer. When the amount is less than 0.1 parts by weight, the available pot life may be effectively extended. When the amount is more than 30 parts by weight, when there will be concerns that the object to be protected may be polluted.

The plasticizer in the present invention may be one or more selected from dioctyl adipate, isodecyl adipate, dioctyl azelate, dioctyl sebacate.

Ionic Compounds or Anti-Static Agents

The amount of ionic compounds, or conductive polymer type antistatic agents depends on the miscibility of the polymer and the ion compound or the conductive polymer type antistatic agent to be used. It is usually 0.01 to 30 parts by weight, preferably 0.03 to 20 parts by weight, and more preferably 0.05 to 10 parts by weight, relative to 100 parts by weight of the polymer.

Example of the ionic compound contains 1-butyl-3-methylpyridine onium bis(trifluoro methanesulfonyl)imide, 1-butyl-3-methylpyridine onium bis(pentafluoro ethanesulfonyl)imide, 1,1-dimethyl pyrrolizidine onium bis(trifluoro methanesulfonyl)imide, 1-methyl-1-ethyl pyrrolizidine onium bis(trifluoro methanesulfonyl)imide, 1-methyl-1-propyl pyrrolizidine onium bis(trifluoro methanesulfonyl)imide, 1-methyl-1-butyl pyrrolizidine onium bis(trifluoro methanesulfonyl)imide, 1-ethyl-1-propyl pyrrolizidine onium bis(trifluoro methanesulfonyl)imide, 1,1-dibutyl pyrrolizidine onium bis(trifluoro methanesulfonyl)imide, 1,1-dimethyl pyrrolizidine onium bis(pentafluoro methanesulfonyl)imide, 1-methyl-1-propyl pyrrolizidine onium bis(pentafluoro methanesulfonyl)imide, etc.

The conductive polymer type antistatic agent can be, for example, commercially available from PEL-20A, PEL-20BBL, PEL-25 and PEL-100(Japan carlit co) and so on.

Cross-Linking Agent

Aliphatic/alicyclic multi-functional isocyanate compounds can be used as the cross-linking agent in the invention to enhance physical properties and reduce the adhesion of the composition. The cross-linking agent can be used alone or in combination.

Multi-functional isocyanate compounds include aromatic isocyanate compounds such as toluene isocyanate and xylene isocyanate, and cycloaliphatic isocyanate such as isophorone diisocyanate.

Usually the amount of the cross-linking agent is preferably 0.01 to 15 parts by weight, more preferably 0.5 to 10 parts by weight relative to 100 parts by weight of (meth)acrylic-based polymer. When it is lower than 0.01 parts by weight, the cross-linking becomes insufficient, and the cohesive strength of the adhesive compositions weakens. In some circumstances, adhesion is excessively large, causing the adhesive residues on the object to be protected. On the other hand, when it is higher than 15 parts by weight, the polymer's cohesive strength becomes larger while the polymer's liquidity becomes lower, which makes the wetting of the object to be protected insufficient and results in releasing effect.

The above-mentioned cross-linked pressure-sensitive adhesive composition is evenly coated on the release layer 30. By drying to remove the solvent, the pressure-sensitive adhesive layer 40 is formed on the release layer 30. Then, then the pressure-sensitive adhesive layer 40 is subject to a curing process so as to adjust transformation of components of the composition or adjust the cross-linking reaction. This pressure-sensitive adhesive layer has a thickness usually in 3-100 μm, preferably 5-50 μm, in order to form a film or strip appearance.

The formation of pressure-sensitive adhesive layer according to the present invention can be achieved by using any conventional method for the preparation of the pressure-sensitive adhesive patch. The conventional method includes roller coating, groove-roller coating, reverse coating, roll brushing, spraying and air-knife coating, and extrusion coating using a die coater.

The top film 50 or the substrate layer 20 of the present invention can be a plastic film or a porous material such as paper or cloth in any form. The top film 50 is adhered onto the pressure-sensitive adhesive layer 40 in order to protect the pressure-sensitive adhesive layer 40.

### Embodiment

The following are examples of specific embodiments of the invention, describing the content and the effect which can be achieved. However, the scope of the invention is not limited to such embodiments.

### I. [Test Method]

### 1. “Measurement of Available Pot Life to be Used”

The obtained acrylic adhesive solution is placed into a 25° C. constant temperature water bath. A Brook Field viscosity meter is used to measure the change in viscosity within 24 hours. The following formula is used to calculate the rate of change in viscosity.

Viscosity change rate %=(the viscosity of the adhesive solution after 24 hrs−the viscosity of adhesive solution at starting point)/the initial viscosity of adhesive solution×100%

### 2. “Measurement of Adhesion Strength to Steel Plate Ground (Adhesion Strength 180 Degree Peeling)”

The obtained pressure-sensitive adhesive specimens are sliced into pieces with 25 mm in width and 180 mm in length. Then a roller of 2 kg attaches a SUS 304 steel plate ground for 30 minutes, with the SUS 304 steel plate ground having been grinded forth and back for 30 times by using a #280 water sandpaper. An anti-stretch testing machine is used to measure the adhesion force to the steel plate ground at 300 mm/min and 2400 mm/min peel speed and peel angle of 180°. The environment for measurement is 23° C.*50% RH. The anti-stretch testing machine used in this invention is the one with model Taiwan Cometech QC-508PA.

### 3. “Measurement of Surface Impedance”

The obtained pressure-sensitive adhesive specimens are cut into pieces of 10 cm in width and 10 cm in length. The test condition is 500V voltage with measurement time of 1 minute.

### 4. “Assessment of Ability to be Stained”

The obtained pressure-sensitive adhesive specimens are cut into pieces with 25 mm in width and 180 mm in length. Then a roller of 2 kg attaches SUS 304 steel plate ground for 30 minutes, with the SUS 304 steel plate ground having been grinded forth and back for 30 times by using a #280 water sandpaper. The pieces are respectively placed in the 23° C.*50% RH environment for 24 hours, one week and one month, then peel the pieces from the roller in order to visually observe the contamination on the steel surface. The evaluation criteria are as shown below.

∘: not polluted
x: polluted

### 5. “Assessment of Heat Aging”

The obtained pressure-sensitive adhesive specimens are cut into pieces with 25 mm in width and 180 mm in length. Then a roller of 2 kg attaches SUS 304 steel plate ground which has been grinded forth and back for 30 times by using a #280 water sandpaper. The pieces are respectively placed in an oven at 90° C. for one week and 150° C. for 3 hours. Visually observe the appearance of the pieces, and the change in adhesion force and adhesive residue at peel speed of 300 mm/min. The evaluation criteria on the appearance are as shown below.

∘: no change
x: there is a change (such as to formation of bubbles, change in color, adhesive residue, etc.)

### 6. “Measurement of Dynamic Mechanical Analyzer (DMA)”

The obtained acrylic polymer (30 weight %) is placed into a releasing paper box of 10 cm*10 cm. The acrylic polymer is heated from 40° C. to dry for one week (note that the pieces should not contain air bubbles). The obtained pieces are subject to temperature scanning by using dynamic mechanical analyzer (DMA). The Dynamic Mechanical Analyzer (DMA) used in the invention is the one of model USA Rheometric RSA III. The conditions for temperature scanning are frequency of 1 Hz and heating rate of 5/min. Values of tan σ and E′ are respectively obtained at different temperatures.

### II. Preparation of (Meth)Acrylic Polymer

### Manufacturing Example 1

### Preparation of Acrylic Polymer (A)

Into a reaction tank with a stirring wing, a thermometer, and condenser, are added 225 parts by weight of acrylic acid 2-ethylhexyl ester, 20 parts by weight of 4-hydroxyl butyl acrylate, 0.3 parts by weight of acrylic acid, 25 parts by weight of methoxy polyethylene glycol (350) acrylate, 0.1 parts by weight of 2,2′-azo-isobutyronitrile as a starting agent for polymerization agent, and 270 parts by weight of ethyl acetate. Nitrogen is charged into the reaction tank while stir slowly. The above solution is heated up to 75° C. Polymerization goes for eight hours at 75° C. to obtain an acrylic polymer (A) solution (30 weight %) with weight average molecular weight of 400,000.

### Manufacturing Example 2

### Preparation of Acrylic Polymer (B)

Into a reaction tank with a stirring wing, a thermometer, and condenser, are added 225 parts by weight of acrylic acid 2-ethylhexyl ester, 20 parts by weight of 4-hydroxyl butyl acrylate, 0.3 parts by weight of acrylic acid, 25 parts by weight of methoxy polyethylene glycol (550) acrylate, 0.1 parts by weight of 2,2′-azo-isobutyronitrile as a starting agent for polymerization agent, and 270 parts by weight of ethyl acetate. Nitrogen is charged into the reaction tank while stir slowly. The above solution is heated up to 75° C. Polymerization goes for eight hours at 75° C. to obtain an acrylic polymer (B) solution (30 weight %) with weight average molecular weight of 300,000.

### Manufacturing Example 3

### Preparation of Acrylic Polymer (C)

Into a reaction tank with a stirring wing, a thermometer, and condenser, are added 200 parts by weight of acrylic acid 2-ethylhexyl ester, 20 parts by weight of 4-hydroxyl butyl acrylate, 0.3 parts by weight of acrylic acid, 50 parts by weight of methoxy polyethylene glycol (350) acrylate, 0.1 parts by weight of 2,2′-azo-isobutyronitrile as a starting agent for polymerization agent, and 270 parts by weight of ethyl acetate. Nitrogen is charged into the reaction tank while stir slowly. The above solution is heated up to 75° C. Polymerization goes for eight hours at 75° C. to obtain an acrylic polymer (C) solution (30 weight %) with weight average molecular weight of 300,000.

### Manufacturing Example 4

### Preparation of Acrylic Polymer (D)

Into a reaction tank with a stirring wing, a thermometer, and condenser, are added 175 parts by weight of acrylic acid 2-ethylhexyl ester, 20 parts by weight of 4-hydroxyl butyl acrylate, 0.3 parts by weight of acrylic acid, 75 parts by weight of methoxy polyethylene glycol (350) acrylate, 0.1 parts by weight of 2,2′-azo-isobutyronitrile as a starting agent for polymerization agent, and 270 parts by weight of ethyl acetate. Nitrogen is charged into the reaction tank while stir slowly. The above solution is heated up to 75° C. Polymerization goes for eight hours at 75° C. to obtain an acrylic polymer (D) solution (30 weight %) with weight average molecular weight of 300,000.

### Manufacturing Example 5

### Preparation of Acrylic Polymer (E)

Into a reaction tank with a stirring wing, a thermometer, and condenser, are added 175 parts by weight of acrylic acid 2-ethylhexyl ester, 20 parts by weight of 4-hydroxyl butyl acrylate, 0.3 parts by weight of acrylic acid, 75 parts by weight of methoxy polyethylene glycol (350) acrylate, 0.13 parts by weight of reactive silane compound A containing acrylic groups, 0.1 parts by weight of 2,2′-azo-isobutyronitrile as a starting agent for polymerization agent, and 270 parts by weight of ethyl acetate. Nitrogen is charged into the reaction tank while stir slowly. The above solution is heated up to 75° C. Polymerization goes for eight hours at 75° C. to obtain an acrylic polymer (E) solution (30 weight %) with weight average molecular weight of 300,000.

### Manufacturing Example 6

### Preparation of Acrylic Polymer (F)

Into a reaction tank with a stirring wing, a thermometer, and condenser, are added 175 parts by weight of acrylic acid 2-ethylhexyl ester, 20 parts by weight of 4-hydroxyl butyl acrylate, 0.3 parts by weight of acrylic acid, 75 parts by weight of methoxy polyethylene glycol (350) acrylate, 0.13 parts by weight of reactive silane compound B containing acrylic groups and epoxy groups, 0.1 parts by weight of 2,2′-azo-isobutyronitrile as a starting agent for polymerization agent, and 270 parts by weight of ethyl acetate. Nitrogen is charged into the reaction tank while stir slowly. The above solution is heated up to 75° C. Polymerization goes for eight hours at 75° C. to obtain an acrylic polymer (F) solution (30 weight %) with weight average molecular weight of 300,000.

### Manufacturing Example 7

### Preparation of Acrylic Polymer (G)

Into a reaction tank with a stirring wing, a thermometer, and condenser, are added 175 parts by weight of acrylic acid 2-ethylhexyl ester, 20 parts by weight of 4-hydroxyl butyl acrylate, 0.3 parts by weight of acrylic acid, 75 parts by weight of methoxy polyethylene glycol (350) acrylate, 1 part by weight of reactive silane compound B containing acrylic groups and epoxy groups, 0.1 parts by weight of 2,2′-azo-isobutyronitrile as a starting agent for polymerization agent, and 270 parts by weight of ethyl acetate. Nitrogen is charged into the reaction tank while stir slowly. The above solution is heated up to 75. Polymerization goes for eight hours at 75° C. to obtain an acrylic polymer (G) solution (30 weight %) with weight average molecular weight of 300,000.

### Manufacturing Example 8

### Preparation of Acrylic Polymer (H)

Into a reaction tank with a stirring wing, a thermometer, and condenser, are added 250 parts by weight of acrylic acid 2-ethylhexyl ester, 20 parts by weight of 4-hydroxyl butyl acrylate, 0.3 parts by weight of acrylic acid, 75 parts by weight of methoxy polyethylene glycol (350) acrylate, 0.1 parts by weight of 2,2′-azo-isobutyronitrile as a starting agent for polymerization agent, and 270 parts by weight of ethyl acetate. Nitrogen is charged into the reaction tank while stir slowly. The above solution is heated up to 75° C. Polymerization goes for eight hours at 75° C. to obtain an acrylic polymer (H) solution (30 weight %) with weight average molecular weight of 400,000.

### Manufacturing Example 12

### Preparation of Acrylic Polymer (I)

Into a reaction tank with a stirring wing, a thermometer, and condenser, are added 250 parts by weight of acrylic acid 2-ethylhexyl ester, 20 parts by weight of 4-hydroxyl butyl acrylate, 0.6 parts by weight of acrylic acid, 0.1 parts by weight of 2,2′-azo-isobutyronitrile as a starting agent for polymerization agent, and 270 parts by weight of ethyl acetate. Nitrogen is charged into the reaction tank while stir slowly. The above solution is heated up to 75° C. Polymerization goes for eight hours at 75° C. to obtain an acrylic polymer (E) solution (30 weight %) with weight average molecular weight of 400,000.

### III. Adhesive Process Embodiment and Comparative Example

### Example 1

### Preparation of Pressure-Sensitive Adhesive Solution

To 100 parts by weight of acrylic polymer (A) (30 weight %) solution, are added 2.5 parts (weight) of plasticizer dioctyl adipate, and 10 (weight) multi-functional isocyanate (Desmodur N-75, manufactured by the BAYER) as a cross-linking agent, and 3 parts (weight) of anti-static agent PEL-20A (Carlit co, Japan). The above ingredients are mixed with stirring, and diluted with ethyl acetate to be a 30 weight % solution for preparing an acrylic adhesive solution 1. Then the viscosity and the rate of change in viscosity are measured by using the above test method.

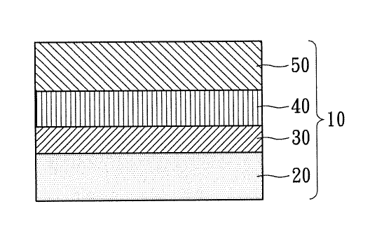

“Preparation of Pressure-Sensitive Adhesive Specimen” (the structure shown in FIG. 1)

An underlying poly (ethylene terephthalate) film 20 (thickness of 25 microns) is taken. A poly-silicon oxide-treated release layer 30 is positioned on the poly (ethylene terephthalate) film 20. Then an acrylic adhesive solution 1 is coated on the release layer 30 and then subjected to heating at 140° C. for 2 minutes to form a pressure-sensitive adhesive layer 40 with the thickness of 20 microns. A top layer polyethylene terephthalate film 50 (thickness of 38 microns) has one side of the top layer polyethylene terephthalate film 50 where has not been subject to anti-static treatment is adhered onto the pressure-sensitive adhesive layer 40. Then the pressure-sensitive adhesive layer 40 is placed at room temperature (25° C.) for 7 days or at 40° C. for 3 days to obtain a pressure-sensitive adhesive specimen 10.

### Example 2

### Preparation of Pressure-Sensitive Adhesive Solution

The pressure-sensitive adhesive solution is obtained by the same method of Example 1, except using the acrylic polymer (B) solution to replace the acrylic polymer (A) solution to obtain an acrylic adhesive solution 2.

“Preparation of Pressure-Sensitive Adhesive Specimen”

The pressure-sensitive adhesive specimen is obtained by the same method of Example 1, except using the acrylic adhesive solution 2 to replace the acrylic adhesive solution 1 to obtain an acrylic adhesive specimen.

### Example 3

### Preparation of Pressure-Sensitive Adhesive Solution

The pressure-sensitive adhesive solution is obtained by the same method of Example 2, except using the acrylic polymer (B) solution to replace the acrylic polymer (B) solution to obtain an acrylic adhesive solution 3.

“Preparation of Pressure-Sensitive Adhesive Specimen”

The pressure-sensitive adhesive specimen is obtained by the same method of Example 2, except using the acrylic adhesive solution 3 to replace the acrylic adhesive solution 2 to obtain an acrylic adhesive specimen.

### Example 4

### Preparation of Pressure-Sensitive Adhesive Solution

The pressure-sensitive adhesive solution is obtained by the same method of Example 3, except using the acrylic polymer (D) solution to replace the acrylic polymer (C) solution to obtain an acrylic adhesive solution 4.

“Preparation of Pressure-Sensitive Adhesive Specimen”

The pressure-sensitive adhesive specimen is obtained by the same method of Example 3, except using the acrylic adhesive solution 4 to replace the acrylic adhesive solution 3 to obtain an acrylic adhesive specimen.

### Example 5

### Preparation of Pressure-Sensitive Adhesive Solution

The pressure-sensitive adhesive solution is obtained by the same method of Example 4, except using 2 parts (weight) of ionic compound AL12 (made by BASF, Germany) to replace 3 parts (weight) anti-static agent PEL-20A to obtain an acrylic adhesive solution 5.

“Preparation of Pressure-Sensitive Adhesive Specimen”

The pressure-sensitive adhesive specimen is obtained by the same method of Example 4, except using the acrylic adhesive solution 5 to replace the acrylic adhesive solution 4 to obtain an acrylic adhesive specimen.

### Example 6

### Preparation of Pressure-Sensitive Adhesive Solution

The pressure-sensitive adhesive solution is obtained by the same method of Example 5, except using the acrylic polymer (E) solution to replace the acrylic polymer (D) solution to obtain an acrylic adhesive solution 6.

“Preparation of Pressure-Sensitive Adhesive Specimen”

The pressure-sensitive adhesive specimen is obtained by the same method of Example 5, except using the acrylic adhesive solution 6 to replace the acrylic adhesive solution 5 to obtain an acrylic adhesive specimen.

### Example 7

### Preparation of Pressure-Sensitive Adhesive Solution

The pressure-sensitive adhesive solution is obtained by the same method of Example 6, except using the acrylic polymer (F) solution to replace the acrylic solution (E) to obtain an acrylic adhesive solution 7.

“Preparation of Pressure-Sensitive Adhesive Specimen”

The pressure-sensitive adhesive specimen is obtained by the same method of Example 6, except using the acrylic adhesive solution 7 to replace the acrylic adhesive solution 6 to obtain an acrylic adhesive specimen.

### Example 8

### Preparation of Pressure-Sensitive Adhesive Solution

The pressure-sensitive adhesive solution is obtained by the same method of Example 7, except using the acrylic polymer (G) solution to replace the acrylic solution (F) to obtain an acrylic adhesive solution 8.

“Preparation of Pressure-Sensitive Adhesive Specimen”

The pressure-sensitive adhesive specimen is obtained by the same method of Example 7, except using the acrylic adhesive solution 8 to replace the acrylic adhesive solution 7 to obtain an acrylic adhesive specimen.

### Comparison Example 1

### Preparation of Pressure-Sensitive Adhesive Solution

The pressure-sensitive adhesive solution is obtained by the same method of Example 1, except using the acrylic polymer (H) solution to replace the acrylic solution (A) to obtain an acrylic adhesive solution 9.

“Preparation of Pressure-Sensitive Adhesive Specimen”

The pressure-sensitive adhesive specimen is obtained by the same method of Example 1, except using the acrylic adhesive solution 9 to replace the acrylic adhesive solution 8 to obtain an acrylic adhesive specimen.

### Comparison Example 2

### Preparation of Pressure-Sensitive Adhesive Solution

The pressure-sensitive adhesive solution is obtained by the same method of Example 1, except using the acrylic polymer (F) solution to replace the acrylic solution (A) to obtain an acrylic adhesive solution 10.

“Preparation of Pressure-Sensitive Adhesive Specimen”

The pressure-sensitive adhesive specimen is obtained by the same method of Example 1, except using the acrylic adhesive solution 10 to replace the acrylic adhesive solution 9 to obtain an acrylic adhesive specimen.

### Comparison Example 3

### Preparation of Pressure-Sensitive Adhesive Solution

The pressure-sensitive adhesive solution is obtained by the same method of Example 1, except using the acrylic polymer (I) solution to replace the acrylic solution (A), without addition of 2.5 parts (weight) plasticizer dioctyl adipate, to obtain an acrylic adhesive solution 11.

“Preparation of Pressure-Sensitive Adhesive Specimen”

The pressure-sensitive adhesive specimen is obtained by the same method of Example 1, except using the acrylic adhesive solution 11 to replace the acrylic adhesive solution 10 to obtain an acrylic adhesive specimen.

### Comparison Example 4

### Preparation of Pressure-Sensitive Adhesive Solution

The pressure-sensitive adhesive solution is obtained by the same method of Example 1, without addition of 2.5 parts (weight) plasticizer dioctyl adipate, to obtain an acrylic adhesive solution 12.

“Preparation of Pressure-Sensitive Adhesive Specimen”

The pressure-sensitive adhesive specimen is obtained by the same method of Example 1, except using the acrylic adhesive solution 12 to replace the acrylic adhesive solution 11 to obtain an acrylic adhesive specimen.

After the specimens of the Examples and Comparison Examples are respectively obtained, properties such as the adhesion, the surface impedance, the ability to be stained and heat aging are measured by using the above test method. The results are listed in Table 2.

### IV. Explanation of Assessment Results

1. From the results in Table 2, when the pressure-sensitive adhesive composition containing the (meth)acrylic polymer that has a plasticizer and an ionic or a conductive polymer type antistatic agent (monomer composition contains (meth)acrylate) epoxy ethyl(propyl)) (Examples 1 to 8), the reliability of adhesion to the steel plate ground is excellent, and the rates of change in viscosity after 24 hours are below at 30% (still effective coating). Meanwhile the surface impedance can be effectively reduced to 10¹¹ to 10⁹Ω/□ without any stain phenomenon.

2. Conversely, when the pressure-sensitive adhesive composition having no plasticizer or the monomers of the polymer has no (meth)acrylate of ethyl(propyl) (compare Examples 1 to 3), the rates of change in viscosity after 24 hours are higher than 30%, and the surface impedance cannot be effectively reduced to 10¹¹Ω/□ which results in contamination.

3. Example 1 and Comparative Example 4 have the same composition of (meth)acrylic polymer (A), both having (meth)acrylate of epoxy ethyl(propyl), except that the latter contains no plasticizers. The rate of the change in viscosity is 42.8%, while the former is only 22.7%, with significant difference in the viscosity change. Quickly peel strength against steel is too high to generate residue contamination.

4. The (meth)acrylic polymers (I) of Comparison Examples 2 and 3 include 0.6 parts (weight) of acrylic acid, accounting for 0.22 wt % of the polymer. The rate of change in viscosity is up to 75% and 81.8%. The former has the plasticizer dioctyl adipate contributing to slightly reduced viscosity change rate.

5. The contaminating properties of Comparison Examples 1-3 are worse than those of Examples 1-3. It is evident that the polymer contains no epoxy ethyl, which makes the ions compound or the conductive polymer type antistatic agent unable to react with the polymer, so that the ionic compound or the conductive polymer type antistatic agent easily releases to cause pollution.

6. Furthermore, in comparison of Examples 6-8, it is found that having reactive silane compounds in the (meth)acrylic polymer can effectively increase the heat aging resistance, prevent the formation of bubbles or excessive variation of adhesion force. By using dynamic mechanical analyzer (DMA) at 50° C., it is proved that the E′ value (storage modulus) indeed increases, at least 4.9×10⁴ dyne/cm² which is higher than other Examples. Accordingly, the pressure-sensitive adhesive composition of the invention is a pressure-sensitive adhesive composition which has available pot life up to 24 hours, and good heat aging and anti-static function, no stains and high reliability of adhesion.

Acrylic polymers of the above formulations are shown in Table 1. The results of Manufacturing Examples and Comparison Examples are shown in Table 2.

TABLE 1
Formula of acrylic polymers

| | Manufacturing Example | | | | | | | | |
|---|---|---|---|---|---|---|---|---|---|
| | Manufac- | Manufac- | Manufac- | Manufac- | Manufac- | Manufac- | Manufac- | Manufac- | Manufac- |
| | turing | turing | turing | turing | turing | turing | turing | turing | turing |
| | Example | Example | Example | Example | Example | Example | Example | Example | Example |
| Monomers | 1(A) | 2(B) | 3(C) | 4(D) | 5(E) | 6(F) | 7(G) | 8(H) | 9(I) |
| Acrylic acid 2 - | 225 | 225 | 200 | 175 | 175 | 175 | 175 | 250 | 250 |
| ethylhexyl ester | | | | | | | | | |
| 4-hydroxide butyl | 20 | 20 | 20 | 20 | 20 | 20 | 20 | 20 | 20 |
| acrylate | | | | | | | | | |
| Acrylic acid | 0.3 | 0.3 | 0.3 | 0.3 | 0.3 | 0.3 | 0.3 | 0.3 | 0.6 |
| Methoxy | 25 | — | 50 | 75 | 75 | 75 | 75 | — | — |
| polyethylene glycol | | | | | | | | | |
| (350) acrylate | | | | | | | | | |
| Methoxy | — | 25 | — | — | — | — | — | — | — |
| polyethylene glycol | | | | | | | | | |
| (550) acrylate | | | | | | | | | |
| Reactive silane | — | — | — | — | 0.13 | — | — | — | — |
| compound A | | | | | | | | | |
| Reactive silane | — | — | — | — | — | 0.13 | 1 | — | — |
| compound B | | | | | | | | | |
| Mw | 400,000 | 300,000 | 300,000 | 300,000 | 300,000 | 300,000 | 300,000 | 400,000 | 400,000 |

The polymerization initiators of the above Manufacturing Examples is 0.1 parts by weight of 2,2′azo double-isobutyronitrile. In the above Manufacturing Examples, 270 parts by weight of ethyl acetate solvent is used.
The reactive silane compound A is silane coupling agent containing acrylic groups.
The reactive silane compound B is a silane polymer containing acrylic and epoxy-groups.

TABLE 2
Formula of pressure-sensitive adhesive solution, and assessment of the pressure-sensitive adhesive specimens

| | | | Example | Example | Example | Example | Example | Example | Example |
|---|---|---|---|---|---|---|---|---|---|
| | | | 1 | 2 | 3 | 4 | 5 | 6 | 7 |
| Formula of | Acrylic polymer | | 100 | 100 | 100 | 100 | 100 | 100 | 100 |
| | | | Manufac- | Manufac- | Manufac- | Manufac- | Manufac- | Manufac- | Manufac- |
| | | | turing | turing | turing | turing | turing | turing | turing |
| | | | Example | Example | Example | Example | Example | Example | Example |
| | | | 1(A) | 2(B) | 3(C) | 4(D) | 4(D) | 5(E) | 6(F) |
| | Octyl adipate | | 2.5 | 2.5 | 2.5 | 2.5 | 2.5 | 2.5 | 2.5 |
| | Cross-linking | | 10 | 10 | 10 | 10 | 10 | 10 | 10 |
| | agent N-75 | | | | | | | | |
| | Anti-static agent | | 3 | 3 | 3 | 3 | — | 3 | 3 |
| | PEL-20A | | | | | | | | |
| | Ionic compound | | — | — | — | — | 2 | — | — |
| | AL12 | | | | | | | | |
| Assessment | Starting | | 220 | 360 | 400 | 370 | 375 | 300 | 320 |
| of specimens | viscosity (cps) | | | | | | | | |
| | Viscosity after | | 270 | 460 | 510 | 460 | 460 | 370 | 400 |
| | 24 hrs (cps) | | | | | | | | |
| | Rate of change | | 22.7 | 27.8 | 27.5 | 24.3 | 22.7 | 23.3 | 25 |
| | in viscosity % | | | | | | | | |
| | Adhesion | 300 mm(g) | 6.07 | 4.26 | 5.94 | 5.47 | 5.52 | 4.91 | 5.7 |
| | strength 180 | 2400 mm (g) | 22.6 | 13.8 | 22.9 | 20.9 | 22.2 | 21.5 | 22.2 |
| | degree peeling | | | | | | | | |
| | Surface | | 1.12 *10¹¹ | 8.34 *10¹⁰ | 4.12 *10¹⁰ | 2.32 *10⁹ | 3.12 *10⁹ | 2.72 *10⁹ | 2.23 *10⁹ |
| | impedance | | | | | | | | |
| | Ω/□ | | | | | | | | |
| | Ability of | | ∘ | ∘ | ∘ | ∘ | ∘ | ∘ | ∘ |
| | being stained | | | | | | | | |
| | Heat aging | | x | x | x | x | x | ∘ | ∘ |
| | Heat | | x | x | x | x | x | ∘ | ∘ |
| | aging(150° C.) | | | | | | | | |
| | DMA | E′ | 3.4 *10⁴ | 3.2 *10⁴ | 3.1 *10⁴ | 3.4 *10⁴ | 3.3 *10⁴ | 4.9 *10⁴ | 5.2 *10⁴ |
| | | (50° C.) | | | | | | | |
| | | dyne/cm² | | | | | | | |

| | | | | Comparison | Comparison | Comparison | Comparison |
|---|---|---|---|---|---|---|---|
| | | | Example 8 | Example 1 | Example 2 | Example 3 | Example 4 |
| Formula of | Acrylic polymer | | 100 | 100 | 100 | 100 | 100 |
| | | | Manufac- | Manufac- | Manufac- | Manufac- | Manufac- |
| | | | turing | turing | turing | turing | turing |
| | | | Example | Example | Example | Example | Example |
| | | | 7(G) | 8(H) | 9(I) | 9(I) | 1(A) |
| | Octyl adipate | | 2.5 | 2.5 | 2.5 | — | — |
| | Cross-linking | | 10 | 10 | 10 | 10 | 10 |
| | agent N-75 | | | | | | |
| | Anti-static agent | | 3 | 3 | 3 | 3 | 3 |
| | PEL-20A | | | | | | |
| | Ionic compound | | — | — | — | — | — |
| | AL12 | | | | | | |
| Assessment | Starting | | 320 | 193 | 200 | 220 | 210 |
| of specimens | viscosity (cps) | | | | | | |
| | Viscosity after | | 405 | 260 | 350 | 400 | 300 |
| | 24 hrs (cps) | | | | | | |
| | Rate of change | | 26.6 | 34.7 | 75 | 81.8 | 42.8 |
| | in viscosity % | | | | | | |
| | Adhesion | 300 mm(g) | 5.6 | 5.38 | 6.31 | 6.83 | 7.62 |
| | strength 180 | 2400 mm (g) | 19.6 | 20.3 | 21.1 | 35.6 | 38.6 |
| | degree peeling | | | | | | |
| | Surface | | 2.52 *10⁹ | 1.42 *10¹² | 1.85 *10¹² | 1.78 *10¹² | 2.34 *10¹¹ |
| | impedance | | | | | | |
| | Ω/□ | | | | | | |
| | Ability of being | | ∘ | x | x | x | x |
| | stained | | | | | | |
| | Heat aging | | ∘ | x | x | x | x |
| | Heat | | ∘ | x | x | x | x |
| | aging(150° C.) | | | | | | |
| | DMA | E′ | 6.0 *10⁴ | 3.2 *10⁴ | 3.2 *10⁴ | 3.3 *10⁴ | 3.3 *10⁴ |
| | | (50° C.) | | | | | |
| | | dyne/cm² | | | | | |

Description:
1. Stain features: ∘: no pollution, x: polluted
2 Heat aging: ∘: no change, x: changed (such as formation of bubbles, change in color, and residual adhesive, etc.)

The descriptions illustrated supra set forth simply the preferred embodiments of the present invention; however, the characteristics of the present invention are by no means restricted thereto. All changes, alternations, or modifications conveniently considered by those skilled in the art are deemed to be encompassed within the scope of the present invention delineated by the following claims.

What is claimed is:

1. A heat-resisting anti-static adhesive film comprising:
a top layer;
a silane-treated release layer;
an underlying substrate layer; and
a pressure-sensitive adhesive layer coated over the release layer,
wherein the composition of the pressure-sensitive adhesive layer comprises:
A. a reactive silane compound containing (methyl)acrylic polymer, in the amount of 100 PHR;
B. a plasticizer in the amount of 0.1 to 30 PHR;
C. an ionic compounds or antistatic agent in the amount of 0.01 to 30 PHR; and
D. a cross-linking agent in the amount of 0.01 to 15 PHR;
the composition having available coating time (pot life) of up to 24 hours and having anti-static property and heat aging resistance.

2. The film of claim 1, wherein the (methyl)acrylic polymer of the pressure-sensitive adhesive comprises:
a. 0.01 to 5% by weight of reactive silane compounds;
b. 0.5 to 30% by weight of (meth)acrylate containing epoxy-ethyl (propyl);
c. 10 to 90% by weight of alkyl(meth)acrylate;
d. 1 to 30% by weight of (meth)acrylate containing hydroxyl; and
e. 0.01 to 0.15% by weight of carboxylic acid monomers.

3. The film of claim 1, wherein the plasticizer is one or more selected from dioctyl adipate, isodecyl adipate, dioctyl azelate, and dioctyl sebacate.

4. The film of claim 2, wherein the reactive silane compound is a silane coupling agent containing acrylic groups, the structural formula being as follows: 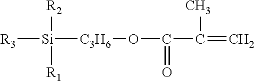
wherein R₁, R₂, R₃ are OCH₃ or OC₂H₅.

5. The anti-static adhesive film of claim 2, wherein the reactive silane compound has the following structure: 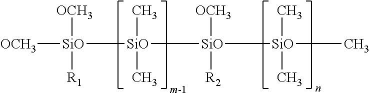
wherein R₁ is an acrylic-containing group; R₂ is a reactive functional group containing OH group, epoxy group, amine group; and m, n are respectively an integer greater than or equal to 1.
